(19) United States
(12) Patent Application Publication
(10) Pub. No.: US 2026/0216662 A1
(43) Pub. Date: Jul. 30, 2026

(54) GAS SEPARATION MEMBRANE, METHOD OF PREPARING THE SAME, AND MODULE INCLUDING THE SAME

(71) Applicant: Samsung Electronics Co., Ltd., Suwon-si (KR)

(72) Inventors: Bokyung JUNG, Suwon-si (KR); Hyoungwoo CHOI, Suwon-si (KR)

(21) Appl. No.: 19/245,828

(22) Filed: Jun. 23, 2025

(30) Foreign Application Priority Data
Jan. 24, 2025 (KR) 10-2025-0011694

(51) Int. Cl. B01D 69/12; B01D 53/22; B01D 67/00; B01D 69/02; B01D 69/10; B01D 71/26; B01D 71/80

(52) U.S. Cl. CPC B01D 69/1216; B01D 53/228; B01D 67/0079; B01D 69/02; B01D 69/107; B01D 69/1213; B01D 71/26; B01D 71/80; B01D 2256/10; B01D 2257/504; B01D 2325/04; B01D 2325/32; B01D 2325/34

(57) ABSTRACT

A gas separation membrane, a method of preparing the gas separation membrane, and a module including the gas separation membrane. The gas separation membrane includes a porous polymer substrate, a porous ceramic-polymer layer on a surface of the porous polymer substrate, and a gas separation layer on an opposite surface of the porous polymer substrate. The gas separation layer may have a thickness of about 0.1% to about 20% relative to the thickness of the porous ceramic-polymer layer, and the porous ceramic-polymer layer has a thickness of about 0.1% to about 50% relative to the thickness of the porous polymer substrate. The porous ceramic-polymer layer may be an organic-inorganic composite layer including a polymer binder having a melting point of 180° C. or greater and a ceramic material.

### CROSS-REFERENCE TO RELATED APPLICATION

This application claims priority to Korean Patent Application No. 10-2025-0011694, filed on Jan. 24, 2025, in the Korean Intellectual Property Office, and all the benefits accruing therefrom under 35 U.S.C. § 119, the disclosure of which in its entirety is incorporated by reference herein.

### BACKGROUND

### 1. Field

The present disclosure relates to a gas separation membrane, a method of preparing the gas separation membrane, and a module including the gas separation membrane.

### 2. Description of the Related Art

To efficiently separate a large amount or volume of gas, a module must be constructed of various components including a gas separation membrane. The performance of the gas separation module depends primarily on the effective membrane area, that is, the actual membrane area excluding the adhesive layer, divided by the module area. To increase the effective membrane area various approaches have been investigated such as increasing the length or width of the membrane, expanding the area of individual membranes, or reducing the thickness of module components.

Among these studies, research on gas separation membranes with a thin film composite (TFC) structure using porous polyolefin supports or heat-resistant porous polymer supports for carbon dioxide (CO₂)/nitrogen (N₂) gas separation is ongoing and of present interest. However, a potential problem with thin film composite structures is thin-film formation and resulting instability under high-temperature and high-pressure conditions.

Therefore, there remains a need for a gas separation membrane with excellent durability, excellent high-temperature dimensional stability, and excellent CO₂ gas separation performance, a method for preparing the gas separation membrane, and a module including the gas separation membrane.

### SUMMARY

Provided is a gas separation membrane with improved durability along with enhanced high-temperature dimensional stability and/or CO₂ gas separation performance.

Provided is a method of preparing the gas separation membrane.

Provided is a module including the gas separation membrane.

Additional aspects will be set forth in part in the description which follows and, in part, will be apparent from the description, or may be learned by practice of the presented embodiments of the disclosure.

According to an aspect of the disclosure, a gas separation membrane includes;
a porous polymer substrate,
a porous ceramic-polymer layer on a surface of the porous polymer substrate, and
a gas separation layer on an opposite surface of the porous polymer substrate,
wherein the gas separation layer has a thickness of about 0.1% to about 20% relative to a thickness of the porous ceramic-polymer layer,
wherein the porous ceramic-polymer layer has a thickness of about 0.1% to about 50% relative to the thickness of the porous polymer substrate,
wherein the porous ceramic-polymer layer is an organic-inorganic composite layer including a polymer binder having a melting point (Tₘ) of 180° C. or greater and a ceramic material,
wherein the polymer binder includes at least one of a cellulose-based binder, a vinyl alcohol-based binder, or an acrylate-based binder, each of which including a functional group on a side chain, and
wherein the functional group has at least one of —COOH, —NH₂, —OH, —SO₃H, or —CN, or a cation thereof, an anion thereof, or a salt thereof.

According to another aspect of the disclosure, a method of preparing a gas separation membrane includes;
providing a porous polymer substrate,
forming a porous ceramic-polymer layer by applying a porous ceramic-polymer layer forming-composition onto a surface of the porous polymer substrate, and
forming a gas separation layer by applying a gas separation layer-forming composition onto an opposite surface of the porous polymer substrate to thereby prepare a gas separation membrane,
wherein the porous ceramic-polymer layer-forming composition includes a polymer binder having a melting point (Tₘ) of 180° C. or greater and a ceramic material,
wherein the polymer binder includes at least one of a cellulose-based binder, a vinyl alcohol-based binder, or an acrylate-based binder, each of which having a functional group on a side chain, and
wherein the functional group includes at least one of —COOH, —NH₂, —OH, —SO₃H, or —CN, or a cation thereof, an anion thereof, or a salt thereof,
wherein the porous ceramic-polymer layer has a thickness of about 0.1% to about 50% relative to the thickness of the porous polymer substrate,
wherein the gas separation layer has a thickness of about 0.1% to about 20% relative to a thickness of the porous ceramic-polymer layer.

According to another aspect of the disclosure, a module includes;
a gas inlet to introduce a feed gas,
at least one feed channel connected to the gas inlet,
at least one permeate channel arranged in parallel and spaced apart from the at least one feed channel,
at least one gas separation membrane disposed between the at least one feed channel and the at least one permeate channel,
a permeate collection member connected to the at least one permeate channel for collecting permeate gas, and
a gas outlet on a side of the module opposite the gas inlet to discharge retentate gas not collected by the permeate collection member,
wherein the at least one gas separation membrane includes
a porous polymer substrate,
a porous ceramic-polymer layer on a surface of the porous polymer substrate, and
a gas separation layer on an opposite surface of the porous polymer substrate,
wherein the gas separation layer has a thickness of about 0.1% to about 20% relative to a thickness of the porous ceramic-polymer layer,
wherein the porous ceramic-polymer layer has a thickness of about 0.1% to about 50% relative to the thickness of the porous polymer substrate,
wherein the porous ceramic-polymer layer is an organic-inorganic composite layer including a polymer binder having a melting point (Tₘ) of 180° C. or greater and a ceramic material,
wherein the polymer binder includes at least one of a cellulose-based binder, a vinyl alcohol-based binder, or an acrylate-based binder, each of which having a functional group on a side chain, and
wherein the functional group may have at least one of —COOH, —NH₂, —OH, —SO₃H, or —CN, or a cation thereof, an anion thereof, or a salt thereof.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of a gas separation membrane according to an embodiment;

FIG. 2 is a schematic cross-sectional view of a gas separation membrane according to another embodiment;

FIG. 3A shows a scanning electron microscopy (SEM) image of a porous polymer substrate of Comparative Reference Example 1 (left) and a magnified SEM image of a surface the porous polymer substrate (right);

FIG. 3B shows an SEM image of a porous polymer substrate/porous ceramic-polymer layer (left) prepared in Reference Example 1 and a magnified SEM image of the porous ceramic-polymer layer surface (right);

FIG. 3C shows an SEM image of a porous polymer substrate/porous ceramic-polymer layer (left) prepared in Reference Example 3 and a magnified SEM image of the porous ceramic-polymer layer surface (right);

FIG. 4A is an SEM image of a porous polymer substrate/porous ceramic-polymer layer prepared in Reference Example 1;

FIG. 4B is an SEM image of an entire gas separation membrane prepared in Example 1;

FIG. 5 is a schematic diagram of a spiral-wound type module according to an embodiment;

FIG. 6 is a schematic diagram of a plate-and-frame type module according to another embodiment;

FIG. 7 is a schematic diagram of a gas separation membrane system for CO₂ capture from flue gas according to an embodiment;

FIG. 8 is a schematic diagram of a gas separation membrane system for CO₂ capture from flue gas according to another embodiment;

FIG. 9 is a schematic diagram for explaining shrinkage rate evaluation (heat resistance evaluation) in machine direction (MD) and transverse direction (TD) for a gas separation membrane sample according to an embodiment;

FIG. 10A is a photograph showing the appearance before heating of a porous polymer substrate of Comparative Reference Example 1 (left), a porous polymer substrate/porous ceramic-polymer layer prepared in Reference Example 1 (center), and a gas separation membrane prepared in Example 1 (right);

FIG. 10B is a photograph showing the appearance after heating at a temperature of 150° C. for 1 hour for a porous polymer substrate of Comparative Reference Example 1 (left), a porous polymer substrate/porous ceramic-polymer layer prepared in Reference Example 1 (center), and a gas separation membrane prepared in Example 1 (right); and

FIG. 11 is a schematic diagram of a gas permeability measurement apparatus used in Evaluation Example 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only, and is not intended to limit the present inventive concept. Singular expressions include plural expressions unless the context clearly indicates otherwise.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements. In the present specification, the expression “at least one,” or “one or more,” preceding a list of elements does not mean that it supplements the entire list of elements nor that it supplements the individual elements of the description. “Or” means “and/or.” As used herein, the term “and/or” includes any and all combinations of one or more of the associated listed items. The term “combination,” unless otherwise specified, includes mixtures, alloys, reaction products, and the like.

In the present specification, the term “comprising,” or “including”, unless otherwise specified, means that other components may be further included, not excluding other components. In the present specification, terms such as “first” and “second” are used to distinguish one element from another, and do not indicate order, quantity, or importance.

Throughout the present specification, “an embodiment,” “embodiment,” and the like mean that a particular element described in connection with the embodiment is included in at least one embodiment described in the present specification and may or may not be present in other embodiments. In addition, it may be understood that the described elements are combined in any suitable manner in various embodiments.

Unless stated otherwise, all percentages, parts, ratios, etc., are by weight. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. It is not intended that the scope of the invention be limited to the specific values recited when defining a range.

Unless otherwise defined, the unit “parts by weight” refers to a weight ratio between components, and the unit “parts by mass” refers to a value obtained by converting a weight ratio between components based on solids.

The term “about” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, the term “about” can mean within one or more standard deviations, or within ±10% or ±5% of the stated value.

Unless otherwise defined, all terms (including technical terms and scientific terms) used herein have the same meaning as commonly understood by one of ordinary skill in the art to which the present disclosure belongs. It should also be understood that terms such as those defined in commonly used dictionaries should be interpreted as having meanings consistent with their meaning in the context of the relevant art and the present disclosure, and should not be interpreted in an idealized sense. Furthermore, such terms should not be interpreted in an overly formal sense.

Example embodiments are described herein with reference to cross section illustrations that are schematic illustrations of idealized examples. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Also, angles illustrated as sharp may be rounded. Thus, the regions illustrated in the figures are schematic in nature and their shapes are not intended to illustrate the precise shape of a region and are not intended to limit the scope of the present claims.

When separating CO₂ from exhaust gas using a gas separation membrane, the exhaust gas can be at high temperature and high pressure. Under these conditions, the gas separation membrane must maintain thermal and mechanical stability, particularly if the gas separation membrane is exposed to the exhaust gas for a long time.

Gas separation membranes have been prepared using materials with heat resistance and mechanical properties such as poly(sulfone), poly(ethersulfone), poly(tetrafluoroethylene), or poly(acrylonitrile) by coating the polymers onto a non-woven fabric, forming a porous membrane through phase inversion, and then coating a polymer layer capable of selectively separating carbon dioxide. Gas separation membranes produced in this manner have a single membrane thickness reaching several micrometers (μm). The structural thickness of the membrane canpose a design problem by necessarily requiring the thickness of other components of a gas separation module. However, even if the thickness of one or more components of the module is reduced, the increase in effective membrane area, i.e., the actual membrane area excluding the adhesive layer divided by the module area, has limitations.

With a focus on some or all of these design points or technical issues, the inventors of the present disclosure have developed a gas separation membrane, preparation method for making the gas separation membrane, and a module including the gas separation membrane, each of which is described in more detail below.

### Gas Separation Membrane 10, 10′

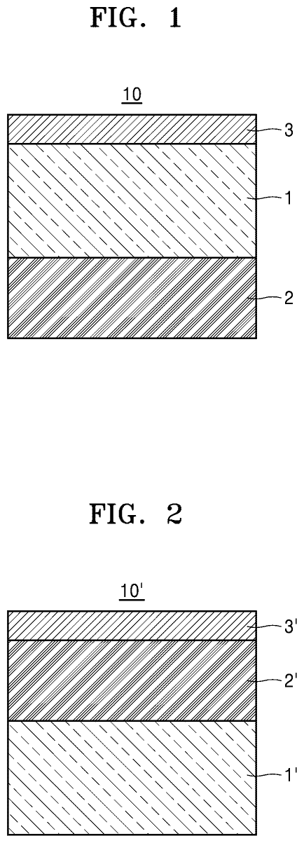

FIG. 1 is a schematic cross-sectional view of a gas separation membrane 10 according to an embodiment. According to FIG. 1, the gas separation membrane 10 may include a porous polymer substrate 1, a porous ceramic-polymer layer 2 on a surface of the porous polymer substrate 1, and a gas separation layer 3 on an opposite surface of the porous polymer substrate 1. The gas separation membrane 10 according to an embodiment may have at least a three-layer structure. The porous polymer substrate 1 may include a polyolefin-based polymer. The polyolefin-based polymer refers to one including 50 wt % or more of a polyolefin such as polyethylene, polypropylene, polyisopropylene, or polybutylene, based on 100 wt % of the total polymer components. The polyolefin-based polymer may include a homopolymer, a copolymer, e.g., a copolymer including ethylene and propylene, a graft polymer, a block copolymer, or a mixture thereof.

The weight average molecular weight (Mw) of the polyolefin-based polymer may be in a range of about 50,000 grams per mole (g/mol) to less than about 5,000,000 g/mol. For example, the weight average molecular weight (Mw) of the polyolefin-based polymer may be in a range of about 100,000 g/mol to less than less than about 4,500,000 g/mol. In the present specification, the weight average molecular weight (Mw) may be measured by gel permeation chromatography.

Optionally, the polyolefin-based polymer may use an ultra-high molecular weight polyolefin, e.g., ultra-high molecular weight polyethylene, alone or as a copolymer for heat resistance or durability. Ultra-high molecular weight polyolefin refers to a polyolefin having a viscosity average molecular weight (Mv) of 300,000 g/mol or more. From the perspective of easy processibility, the viscosity average molecular weight (Mv) of the ultra-high molecular weight polyolefin may be 4,000,000 g/mol or less. In the present specification, the viscosity average molecular weight (Mv) can be measured using an Ubbelohde viscometer.

The average pore size of the porous polymer substrate 1 may be about 50 nanometers (nm) to about 80 nm. For example, the average pore size of the porous polymer substrate 1 may be about 50 nm to about 70 nm, or about 50 nm to about 60 nm. Within the aforementioned average pore size range, the porous polymer substrate 1 may have small pore sizes and a narrow pore distribution, allowing a thin-film substrate to be easily manufactured.

The porosity of the porous polymer substrate 1 may be about 25 vol % or more to 80 vol %, about 30 vol % to about 70 vol %, or about 40 vol % to about 70%, based on 100 vol % of the total volume of the polymer substrate 1. Within the aforementioned porosity range, the porous polymer substrate 1 may sufficiently secure gas permeability and mechanical strength.

The thickness of the porous polymer substrate 1 may be about 10 micrometers (μm) to about 40 μm. For example, the thickness of the porous polymer substrate 1 may be about 10 μm to about 35 μm, about 10 μm to about 30 μm, about 10 μm to about 28 μm, about 10 μm to about 26 μm, about 10 μm to about 24 μm, about 10 μm to about 22 μm, about 10 μm to about 20 μm, about 10 μm to about 18 μm, or about 10 μm to about 16 μm. The porous polymer substrate 1 may possess excellent mechanical strength even within the aforementioned relatively thin film thickness range.

The porous ceramic-polymer layer 2 may be located on a surface of the porous polymer substrate 1. The porous ceramic-polymer layer 2 may be an organic-inorganic composite layer comprising a polymer binder having a melting point (Tₘ) of 180° C. or greater and a ceramic material.

The porous ceramic-polymer layer 2 may have a structure in which the ceramic material is connected and fixed by the polymer binder. The ceramic material may exist dispersed in the polymer binder in the form of particles at a uniform density.

According to an embodiment, the ceramic material may be a spherical ceramic material having an average particle size of about 0.1 μm to about 1 μm, a plate-shaped ceramic material having an average particle size of about 0.1 μm to about 10 μm, or a ceramic material with a mixed structure thereof.

Examples of the spherical ceramic material may include at least one of alumina (Al₂O₃), boehmite (γ-AlO(OH)), or silica (SiO₂). The spherical ceramic material has empty spaces between numerous ceramic particles, forming micropores of less than 1 μm. The spherical ceramic material has excellent heat resistance and can prevent the porous ceramic-polymer layer 2 and the gas separation membrane including the ceramic material from undergoing rapid shrinkage or deformation even under high-temperature conditions.

The average particle size of the spherical ceramic material may be about 0.1 μm to about 1 μm. If the average particle size of the spherical ceramic material is less than 0.1 μm, the dispersibility of the particles decreases, which may make it more difficult to form a uniform porous ceramic-polymer layer 2. On the other hand, if the average particle size of the ceramic material exceeds 1 μm, the mechanical properties and gas separation performance may be degraded.

In the present specification, the average particle size refers to the “D₅₀” value. The “D₅₀ value” refers to the value of the particle size corresponding to 50% from the smallest particle when the total number of particles is taken as 100%, in a cumulative distribution curve ordered from the smallest particle size to the largest particle size. Methods for measuring the average particle size (D₅₀) of a ceramic material with a two-dimensional or three-dimensional structure include measurement with a particle size analyzer, or it can also be measured from TEM images or SEM images. Alternatively, it may be obtained through calculation after measuring using a measurement apparatus employing dynamic light-scattering and performing data analysis to count the number of particles for each particle size range.

Examples of the plate-shaped ceramic material may include at least one of magnesium hydroxide (Mg(OH)₂), aluminum hydroxide (Al(OH)₃), mica, clay, or talc. The average particle size of the plate-shaped ceramic material may be about 0.1 μm to about 10 μm. If the average particle size of the plate-shaped ceramic material is less than 0.1 μm, the dispersibility of the particles decreases, which may make it more difficult to form a uniform porous ceramic-polymer layer 2. On the other hand, if the average particle size of the plate-shaped ceramic material exceeds 10 μm, the mechanical properties and gas separation performance may be degraded.

The polymer binder enables the spherical and/or plate-shaped ceramic material particles to be uniformly dispersed without mutual aggregation and ensures a good adhesion to the porous polymer substrate 1. According to an embodiment, the polymer binder may include at least one of a cellulose-based binder, a vinyl alcohol-based binder, or an acrylate-based binder, each of which having a functional group on a side chain. The functional group may include at least one of —COOH, —NH₂, —OH, —SO₃H, or —CN, or a cation thereof, an anion thereof, or a salt thereof.

For example, the polymer binder may include: cellulose-based binders such as hydroxypropyl methylcellulose (HPMC), hydroxyethyl methylcellulose (HEMC), hydroxyethyl cellulose (HEC), carboxymethyl cellulose (CMC); vinyl alcohol-based binders such as polyvinyl alcohol (PVA); and acrylic binders such as polyacrylic acid (PAA), polyacrylate salts, polymethacrylic acid, polyacrylates, 2-hydroxyacrylate, 4-hydroxybutyl acrylate, 2-hydroxyethyl acrylate, 2-hydroxypropyl acrylate, 2-hydroxy-3-phenoxypropyl acrylate, polyurethane acrylate, polymethacrylates, polyacrylamide, polymethacrylamide, polyacrylonitrile, polymethacrylonitrile, polyetheracrylonitrile, and the like. The polymer binder may be used alone, as a mixture of two or more types of the aforementioned polymer binders, or as a copolymer of two or more types (structural units) of the aforementioned polymer binders.

Because the functional groups in the side chains of the polymer binder are hydrophilic functional groups, the polymer may more easily adsorb onto the surface of the ceramic material, which has a hydrophilic surface, forming a binder surface adsorption layer. These binder surface adsorption layers may then bind with adjacent adsorption layers to form a robust membrane.

Among acrylic binders, the weight average molecular weight of the acrylic copolymer may be about 200,000 g/mol to about 700,000 g/mol, for example, about 200,000 g/mol to about 600,000 g/mol, or about 300,000 g/mol to about 700,000 g/mol. When the weight average molecular weight of the acrylic copolymer satisfies the aforementioned range, the porous ceramic-polymer layer 2 including the acrylic copolymer can exhibit excellent adhesive strength, heat resistance, air permeability, and/or the like.

Among cellulose-based binders, the weight average molecular weight of carboxymethyl cellulose (CMC) may be about 50,000 g/mol to about 250,000 g/mol, for example, about 70,000 g/mol to about 250,000 g/mol, or about 10,000 g/mol to about 250,000 g/mol.

The vinyl alcohol-based binder may be a polymer including repeating units having-OH functional groups, or a polyvinyl alcohol-based polymer in which a part of the —OH functional groups is modified with functional groups such as carboxyl groups, sulfonic acid groups, amino groups, silanol groups, thiol groups, and the like. The weight average molecular weight of the polyvinyl alcohol-based polymer may be about 10,000 g/mol to about 50,000 g/mol, for example, about 15,000 g/mol to about 30,000 g/mol.

The weight average molecular weight described in the present specification may be the polystyrene equivalent average molecular weight measured using gel permeation chromatography.

The weight ratio of the polymer binder to the ceramic material may be about 1:8 to about 1:45. When the weight ratio of the polymer binder to the ceramic material is within this range, sufficient dispersion stability of the ceramic material in the polymer binder may be secured, and/or the porous ceramic-polymer layer 2 is formed uniformly, thereby providing a gas separation membrane having improved high-temperature dimensional stability and CO₂ gas separation performance.

The pore size of the porous ceramic-polymer layer 2 may be about 10 nm to about 999 nm. For example, the pore size of the porous ceramic-polymer layer 2 may be about 10 nm to about 500 nm. Because micropores in the above range are formed, the porous ceramic-polymer layer 2 can exhibit excellent CO₂ gas permeability. The porosity of the porous ceramic-polymer layer 2 may be about 25 vol % or more to 60 vol % or less, or 30 vol % or more to 50 vol % or less, based on 100 vol % of the total pores. Within the above porosity range, the porous ceramic-polymer layer 2 can exhibit excellent CO₂ gas permeability and improved high-temperature dimensional stability.

The porous ceramic-polymer layer 2 located on a surface of the porous polymer substrate 1 may have a thickness of about 0.1% to about 50% relative to the thickness of the porous polymer substrate 1. For example, the porous ceramic-polymer layer 2 may have a thickness of about 1% to about 48%, about 3% to about 45%, about 5% to about 42%, about 7% to about 40%, about 9% to about 38%, about 11% to about 35%, about 13% to about 32%, or about 15% to about 32%, relative to the thickness of the porous polymer substrate 1. The porous ceramic-polymer layer 2 can exhibit excellent high-temperature dimensional stability even within the above thin film thickness range.

The gas separation layer 3 may be located on an opposite surface of the porous polymer substrate 1. The gas separation layer 3 may perform the role of permeating a specific gas from exhaust gas or flue gas. The gas separation layer 3 may include a polymer or copolymer that preferentially permeates CO₂ gas.

The gas separation layer 3 may include a polymer or copolymer including C1-C5 alkylene oxide structural units in the main chain. The weight average molecular weight (Mw) of the polymer or copolymer may be about 50,000 g/mol to about 200,000 g/mol, about 60,000 g/mol to about 150,000 g/mol, or may be about 70,000 g/mol to about 150,000 g/mol. For example, the polymer including C1-C5 alkylene oxide structural units in the main chain may be a crosslinked type C1-C5 alkylene oxide. The crosslinked type C1-C5 alkylene oxide is a copolymer including C1-C5 alkylene oxide repeating units, and may be a polymer having double bonds or carboxyl groups, amine groups, hydroxyl groups, or cyano groups, etc., at both end portions, and which is capable of being crosslinked by heat or light after a coating application.

The crosslinked type C1-C5 alkylene oxide may exhibit superior CO₂ gas permeability.

The crosslinked type C1-C5 alkylene oxide may be formed by a reaction initiated by electron beam irradiation or UV, heat, etc.

The content of the C1-C5 alkylene oxide structural unit may be about 50 wt % to about 100 wt % based on 100 wt % of the total structural units in the main chain. For example, the content of the C1-C5 alkylene oxide structural unit may be about 50 wt % to about 90 wt % or about 50 wt % to about 80 wt %, based on 100 wt % of the total structural units in the main chain.

The copolymer may include a block copolymer including C1-C5 alkylene oxide rubbery structural units and hard structural units in the main chain. The rubbery structural unit may have a glass transition temperature of about −80° C. to about −50° C. The hard structural unit may have a melting point of about 180° C. to about 200° C. For example, the hard structural unit may include at least one of polyamide, polybutylene terephthalate, polybutadiene, polychloroprene, or polyurethane.

For example, the copolymer may include a block copolymer including C1-C5 alkylene oxide structural units and amide structural units. The alkylene oxide repeating unit may have a glass transition temperature of about −80° C. to about −40° C. For example, the alkylene oxide repeating unit may have a glass transition temperature of about −70° C. to about −40° C., or about −60° C. to about −40° C.

Optionally, the gas separation layer 3 may further include polymers such as polyacrylic acid, polyvinyl alcohol, polyethyleneimine, polyvinylamine, polyallylamine, or polyvinylpyrrolidone, and the like.

Optionally, the gas separation layer 3 may include additives such as a radical scavenger, a peroxide decomposer, a surfactant, a filler, or a crosslinking agent. The content of the additive may be about 0.01 wt % to about 5 wt % based on 100 wt % of the entire gas separation layer 3.

The gas separation layer 3 may have a thickness of about 0.1% to about 20% relative to the porous ceramic-polymer layer. For example, the gas separation layer 3 may have a thickness of about 0.1% to about 18%, about 0.1% to about 16%, about 0.1% to about 14%, about 0.1% to about 12%, or about 0.1% to about 10%, relative to the porous ceramic-polymer layer. Even within the above thin film thickness range, the gas separation layer 3 can exhibit improved CO₂/N₂ selectivity and improved high-temperature dimensional stability.

The gas separation layer 3 may be a layer that separates CO₂/N₂ gases present in a feed gas.

CO₂/N₂ selectivity

$$( S \frac{CO 2}{N 2} )$$

of the gas separation membrane 10, as defined by Equation 1, may be about 20 to about 100:

$$S \frac{CO 2}{N 2} = \frac{Carbon dioxide ( CO 2 ) permeability}{Nitrogen ( N 2 ) permeabi1ity} . \qquad [ Equation 1 ]$$

The shrinkage rate in both a machine direction (MD) and a transverse direction (TD) of the gas separation membrane 10, as defined by Equation 2, may be greater than 0% and less than 5%:

$$Shrinkage rate ( \% ) = [ \frac{( 1 - D h )}{D 0} \times 100 ] \qquad [ Equation 2 ]$$

In Equation 2,
D0 may represent the length of the gas separation membrane before heating in the MD or TD direction, and
Dh may represent the length of the gas separation membrane in the MD or TD direction after heating at 150° C. for 1 hour.

FIG. 2 is a schematic cross-sectional view of a gas separation membrane 10′ according to an embodiment. According to FIG. 2, in the gas separation membrane 10′ according to an embodiment, a porous ceramic-polymer layer 2′ and a gas separation layer 3′ are sequentially arranged on one surface of a porous polymer substrate 1′. Specific details regarding the composition, content, thickness, and properties of the porous polymer substrate 1′, the porous ceramic-polymer layer 2′, the gas separation layer 3′, and the gas separation membrane 10′ are the same as described above, and thus further explanation is omitted.

### Method of Preparing a Gas Separation Membrane 10, 10′

According to a method of preparing a gas separation membrane 10 may include: providing a porous polymer substrate 1; forming a porous ceramic-polymer layer 2 by applying a porous ceramic-polymer layer-forming composition onto a surface of the porous polymer substrate 1; and forming a gas separation layer 3 by applying a gas separation layer-forming composition onto an opposite surface of the porous polymer substrate 1 to prepare the gas separation membrane 10. The porous ceramic-polymer layer-forming composition may include a polymer binder having a melting point (Tₘ) of 180° C. or greater and a ceramic material. The polymer binder may include at least one of a cellulose-based binder, a vinyl alcohol-based binder, or an acrylate-based binder, each of which having a functional group on a side chain. The functional group may include at least one of —COOH, —NH₂, —OH, —SO₃H, or —CN, or a cation thereof, an anion thereof, or a salt thereof. The porous ceramic-polymer layer 2 may have a thickness of about 0.1% to about 50% relative to a thickness of the porous polymer substrate, and the gas separation layer 3 has a thickness of about 0.1% to about 20% relative to a thickness of the porous ceramic-polymer layer 2.

The porous polymer substrate 1 may be provided. The porous polymer substrate 1 may include a polyolefin-based polymer. Examples of the polyolefin-based polymer include homopolymers of polyethylene, polypropylene, polyisopropylene, or polybutylene, copolymers thereof, graft polymers thereof, block copolymers thereof, or mixtures thereof. Optionally, the polyolefin-based polymer may also include a mixture of a polyolefin polymer and a non-polyolefin polymer or a copolymer of an olefin and a non-olefin monomer.

The weight average molecular weight (Mw) of the polyolefin-based polymer may be about 50,000 g/mol to less than about 5,000,000 g/mol, about 100,000 g/mol to less than about 2,000,000 g/mol, or about 200,000 g/mol to less than about 1,000,000 g/mol.

The average pore size of the porous polymer substrate 1 may be about 50 nm to about 200 nm, about 50 nm to about 100 nm, or about 50 nm to about 70 nm. The porosity of the porous polymer substrate 1 may be about 10 vol % or more to 30 vol % or less, or 10 vol % or more to 20 vol % or less, based on 100 vol % of the total pores.

The thickness of the porous polymer substrate 1 may be about 10 μm to about 40 μm. For example, the thickness of the porous polymer substrate 1 may be about 10 μm to about 35 μm, about 10 μm to about 30 μm, about 10 μm to about 28 μm, about 10 μm to about 26 μm, about 10 μm to about 24 μm, about 10 μm to about 22 μm, about 10 μm to about 20 μm, about 10 μm to about 18 μm, or about 10 μm to about 16 μm.

Next, a porous ceramic-polymer layer-forming composition may be applied to a surface of the porous polymer substrate 1 to form the porous ceramic-polymer layer 2.

The porous ceramic-polymer layer-forming composition may be a slurry including a mixture of a polymer binder having a melting point (Tₘ) of 180° C. or greater, a ceramic material, and a solvent. The porous ceramic-polymer layer-forming composition may be prepared by mixing a polymer binder having a melting point (Tₘ) of 180° C. or greater and a solvent to prepare a mixed solution and then adding and dispersing a ceramic material into the mixed solution to prepare the slurry.

The solvent may include water, deionized water, or a water-soluble organic solvent. Examples of the water-soluble organic solvent may include: alcohol-based solvents such as ethanol, propanol, butanol, 1,5-pentanediol, 1-methylamino-2,3-propanediol; lactone-based solvents such as ε-caprolactone, α-acetyl γ-butyrolactone; glycol-based solvents such as diethylene glycol, 1,3-butylene glycol, propylene glycol; glycol ether-based solvents such as triethylene glycol dimethyl ether, tripropylene glycol dimethyl ether, diethylene glycol monobutyl ether; carbonate-based solvents such as propylene carbonate, ethylene carbonate; and the like. The aforementioned water-soluble organic solvents may be used alone or in combination of two or more thereof.

A commercial method may be used as the mixing method, and for example, it can be carried out using a mixer equipped with a planetary and Desper. The mixing time may proceed for about 1 hour to about 20 hours. Alternatively, as a mixing method, the slurry may also be prepared by charging the polymer binder having a melting point (Tₘ) of 180° C. or greater, the ceramic material, and the solvent all at once into a stirring vessel and mixing with a stirring blade.

Optionally, a grinding process for the ceramic material may be carried out before or after preparing in slurry form. A commercial method may be used as the grinding method, and for example, a milling method such as ball milling or bead milling may be used.

The weight ratio of the polymer binder to the ceramic material may be about 1:8 to about 1:45. When the weight ratio of the polymer binder to the ceramic material is within this range, sufficient dispersion stability of the ceramic material in the polymer binder may be secured, and/or the porous ceramic-polymer layer 2 is formed uniformly, thereby providing a gas separation membrane having improved high-temperature dimensional stability and CO₂ gas separation performance.

Regarding the particle size, structure, and type of the ceramic material, and the type of the polymer binder, these are the same as described above, and thus further explanation is omitted.

A commercial method can be used as the application coating method, and for example, dip coating, spin coating, roll coating, Meyer bar coating, comma coating, die coating, gravure coating, screen printing, offset printing, brush painting, spray method, or a combination thereof can be used. After application, the applied coating may be dried at room temperature or in an oven may produce the porous ceramic-polymer layer 2.

The pore size of the porous ceramic-polymer layer 2 may be about 10 nm to about 999 nm. For example, the pore size of the porous ceramic-polymer layer 2 may be about 10 nm to about 500 nm or about 30 nm to about 300 nm.

The porosity of the porous ceramic-polymer layer 2 may be about 10 vol % or more to 50 vol % or less, or 15 vol % or more to 30 vol % or less, based on 100 vol % of the total pores.

The porous ceramic-polymer layer 2 located on one surface of the porous polymer substrate 1 has a thickness of about 0.1% to about 50% relative to the thickness of the porous polymer substrate 1. For example, the porous ceramic-polymer layer 2 may have a thickness of about 1% to about 48%, about 3% to about 45%, about 5% to about 42%, about 7% to about 40%, about 9% to about 38%, about 11% to about 35%, about 13% to about 32%, or about 15% to about 32%, relative to the thickness of the porous polymer substrate 1.

Next, a gas separation layer-forming composition may be applied to an opposite surface of the porous polymer substrate 1 to form the gas separation layer 3, thereby manufacturing the gas separation membrane 10, 10′ of FIG. 1 and FIG. 2, respectively. The gas separation layer-forming composition may be a slurry comprising a mixture of a polymer or copolymer containing C1-C5 alkylene oxide structural units in the main chain and a solvent.

The solvent may include water, deionized water, or a water-soluble organic solvent. Examples of the water-soluble organic solvent may include the aforementioned alcohol-based, lactone-based, glycol-based, glycol ether-based, carbonate-based solvents, and the like.

A mixed solvent comprising a mixture of water or deionized water and a water-soluble organic solvent may be used. The weight ratio of the mixed solvent may be about 7:3 to about 8:2. Within the above weight ratio range, the mixed solvent can provide more improved CO₂/N₂ selectivity and high-temperature dimensional stability.

The content of the C1-C5 alkylene oxide structural unit may be about 50 wt % to about 100 wt % based on 100 wt % of the total structural units in the main chain. For example, the content of the C1-C5 alkylene oxide structural unit may be about 50 wt % to about 90 wt % or about 50 wt % to about 80 wt % based on 100 wt % of the total structural units in the main chain.

The copolymer may include a block copolymer including, in a main chain thereof, C1-C5 alkylene oxide rubbery structural units and hard structural units. The rubbery structural unit may have a glass transition temperature of about −80° C. to about −50° C. The hard structural unit may have a melting point of about 180° C. to about 200° C. For example, the hard structural unit may include at least one selected from polyamide, polybutylene terephthalate, polybutadiene, polychloroprene, and polyurethane.

Optionally, the gas separation layer-forming composition may include polymers such as polyacrylic acid, polyvinyl alcohol, polyethyleneimine, polyvinylamine, polyallylamine, polyvinylpyrrolidone or a mixture thereof.

Optionally, additives such as a radical scavenger, a peroxide decomposer, a surfactant, a filler, or a crosslinking agent may be further added to the gas separation layer-forming composition. The content of the additive may be about 0.01 wt % to about 5 wt % based on 100 wt % of the entire gas separation layer 3.

The mixing method, application method, and drying for the gas separation layer-forming composition are the same as the mixing method, application method, and drying for forming the porous ceramic-polymer layer 2, and thus further explanation is omitted.

The gas separation layer 3 may have a thickness of about 0.1% to about 20% relative to the porous ceramic-polymer layer 2. For example, the gas separation layer 3 may have a thickness of about 0.1% to about 18%, about 0.1% to about 16%, about 0.1% to about 14%, about 0.1% to about 12%, or about 0.1% to about 10% relative to the porous ceramic-polymer layer 2.

The gas separation layer 3 may be a layer that separates CO₂/N₂ gases.

According to another embodiment, a method of preparing the gas separation membrane 10′ includes: a step of providing a porous polymer substrate 1′; a step of applying a porous ceramic-polymer layer-forming composition to a surface of the porous polymer substrate 1′ to form a porous ceramic-polymer layer 2′; and a step of applying a gas separation layer-forming composition to a surface of the porous ceramic-polymer layer 2′ opposite the porous polymer substrate 1′ to form a gas separation layer 3′, thereby manufacturing the gas separation membrane 10′.

A description of the specific steps for providing the porous polymer substrate 1′, forming the porous ceramic-polymer layer 2′, and forming the gas separation layer 3′ to manufacture the gas separation membrane 10′ is the same as described above, and thus further explanation is omitted hereinafter.

### Module Including Gas Separation Membrane 10, 10′

According to another embodiment, a module includes: a gas inlet to introduce a feed gas; at least one feed channel connected to the gas inlet; at least one permeate channel arranged in parallel and spaced apart from the at least one feed channel; at least one gas separation membrane disposed between the at least one feed channel and the at least one permeate channel; a permeate collection member connected to the at least one permeate channel for collecting permeate gas; and a gas outlet on a side of the module opposite the gas inlet to discharge retentate gas not collected in the permeate collection member.

The module according to an exemplary embodiment may be the following module.

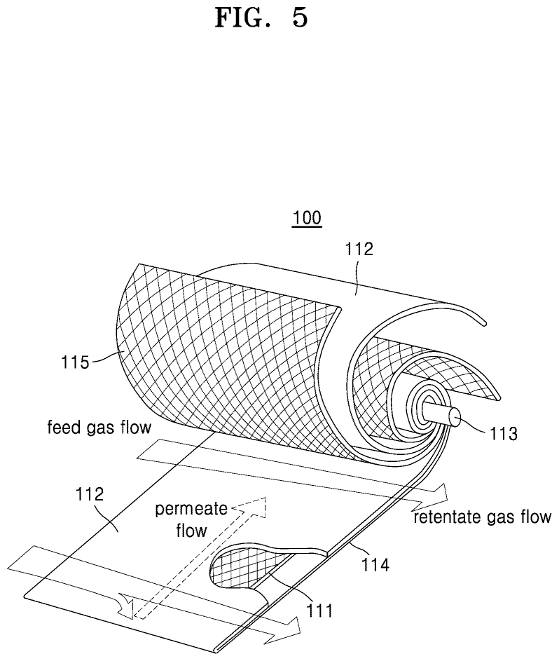

FIG. 5 is a schematic diagram of a spiral-wound type module 100 according to an embodiment. According to FIG. 5, a spiral-wound type module 100 according to an embodiment is a module with a structure in which a plurality of packets, packet including a feed channel 115 with a spacer, a gas separation membrane 112, and a permeate channel 111 with a spacer, are spirally wound around a permeate collection porous tube member 113 connected to the permeate channel 111. The spacers of the feed channel 115 and the permeate channel 111 may each be in a mesh form. The gas separation membrane envelope 114 may be sealed with an adhesive. The exterior of the module may be wrapped with glass fiber.

The spiral-wound type module 100 may have a gas inlet located at one end (left side) through which flue gas containing CO₂, N₂, etc., is introduced into the module. For example, the flue gas feed gas may flow in by applying pressure to the gas inlet. The introduced feed gas passes through the gas separation membrane 112, and a retentate gas stream diluted in CO₂ may exist at the opposite end. The gas separation membrane 112 may be the aforementioned gas separation membrane 10, 10′. The gas separation membrane 112 is a membrane with high CO₂ gas selectivity, allowing CO₂ gas to preferentially permeate into the interior of the gas separation membrane envelope 114. The permeate gas, i.e., CO₂ gas, can flow downward along the gas separation membrane envelope 114 under vacuum in a direction crossing the feed flow and be collected in the permeate collection porous tube 113. Alternatively, the permeate gas, driven by a pressure difference, can flow through the permeate channel 111 in a direction crossing the feed flow, allowing it to enter the holes of the permeate collection porous tube member 113. Optionally, a pipe plug may be located in the middle of the permeate collection porous tube 113, allowing a portion of the CO₂ gas to permeate outward without backflow. A gas outlet is located where the retentate gas, not collected in the permeate collection porous tube member 113, exits.

The packing density of the spiral-wound type module 100 may be 200 m²/m³ to 1,000 m²/m³. Packing density has the same meaning as effective membrane area/module volume. The aforementioned spiral-wound type module 100 has a high packing density, thus providing a module with improved performance compared to those using flat sheet membranes.

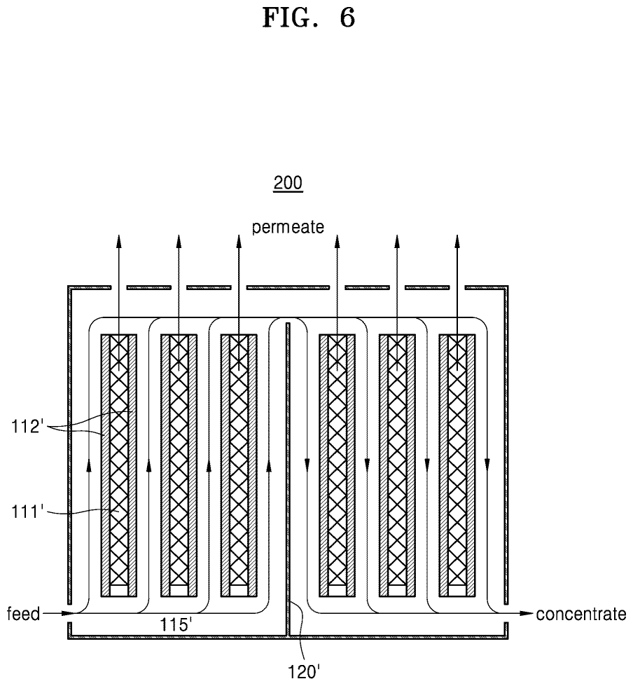

FIG. 6 is a schematic diagram of a plate-and-frame type module 200 according to another embodiment. According to FIG. 6, the plate-and-frame type module 200 is a module structured such that two membrane sets are stacked in a frame in a sandwich-like form and arranged facing the gas inlet through which the feed gas is introduced. The membrane set as shown includes feed channels 115′, gas separation membranes 112′, and permeate channels 111′ with spacers, which are alternately stacked. The spacer of the permeate channel 111′ may be in a mesh form. Although not shown in the feed channel 115′, it may include a mesh-type spacer. At least one baffle 120′ may be included between adjacent feed channels. The baffle 120′ serves to improve the flow of the feed gas. For example, the baffle 120′ may be in a cylindrical shape with multiple through-holes formed on its surface. The gas separation membrane 112′ may be the aforementioned gas separation membrane 10, 10′. The gas separation membrane 112′ is a membrane with high CO₂ gas selectivity; CO₂ gas can flow upward under vacuum in a direction crossing the feed stream from the gas inlet where the flue gas enters and permeates through. The unpermeated, CO₂-concentrated gas (retentate) exits through the gas outlet located on an opposite side of the gas inlet.

The packing density of the plate-and-frame type module 200 may be about 30 m²/m³ to about 500 m²/m³. The plate-and-frame type module 200 may have the lowest pressure drop.

### System Using Gas Separation Membrane 10, 10′

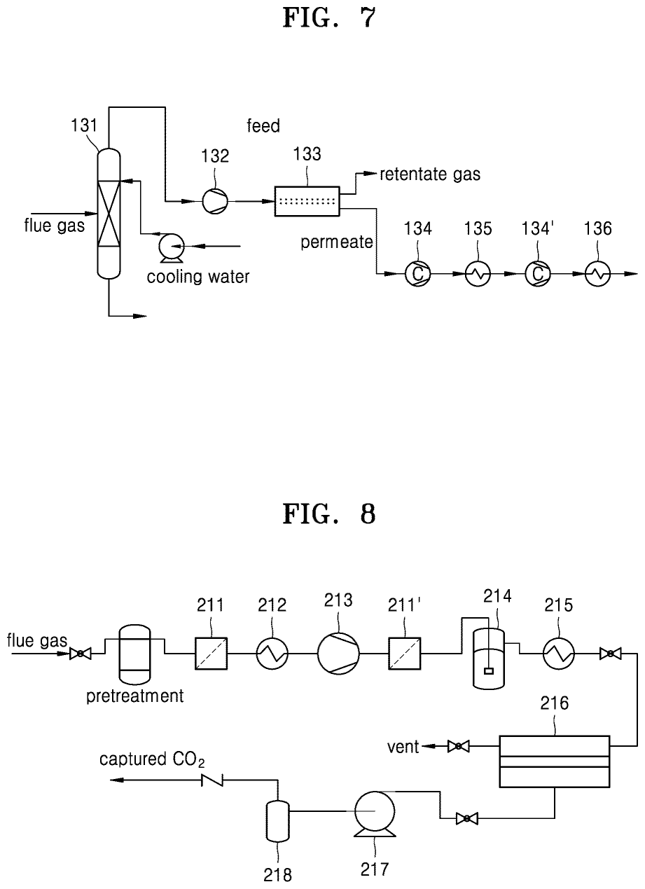

According to an embodiment, a system using the gas separation membrane 10, 10′ may be the following system. FIG. 7 is a schematic diagram of a gas separation membrane system for CO₂ capture from flue gas according to an embodiment.

According to the embodiment, FIG. 7 is a schematic of a gas separation membrane system for CO₂ capture from flue gas, e.g., flue gas containing CO₂, N₂, etc. The flue gas may first pass into a wet scrubber 131. In the wet scrubber 131, the introduced flue gas may be cooled to the operating temperature of the gas separation membrane 133. The cooled flue gas passes through a compressor 132 and is supplied into the module 133 including the gas separation membrane in accordance with an embodiment. Some CO₂ permeate gas that has passed through the module 133 including the gas separation membrane and concentrated CO₂ gas (stream) are obtained on the permeate side. Meanwhile, the flue gas exits as retentate gas through the gas outlet. Since the partial pressure of CO₂ gas is very small, the partial pressure difference between the feed side and the permeate side is increased using the compressor 132 and vacuum pumps 134, 134′. The concentrated CO₂ permeate gas is cooled through an Intercooling 135 stage between the vacuum pumps 134, 134′ and an aftercooling 136 stage after the vacuum pump 134′.

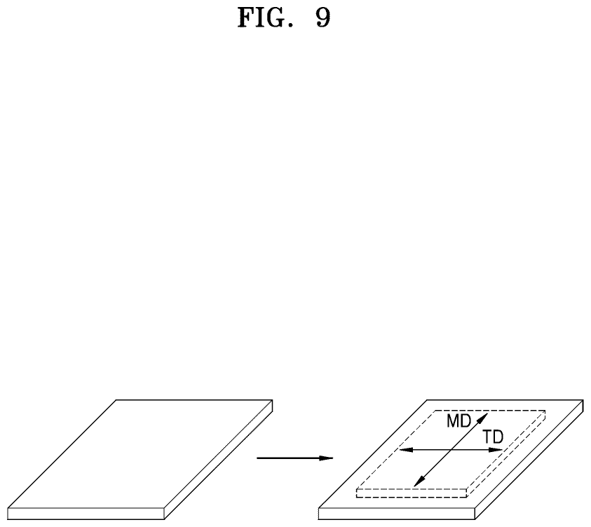

FIG. 8 is a schematic diagram of a gas separation membrane system for CO₂ capture from flue gas according to another embodiment. According to the gas separation membrane system for CO₂ capture from flue gas according to another embodiment of FIG. 8, flue gas containing CO₂, N₂, etc., undergoes pretreatment, passes through a filter 211 for contaminant removal, and then passes through a cooler 212 to remove moisture. The flue gas with moisture removed is transferred to a compressor 213. The flue gas that has passed through the compressor 213 is humidified in a humidifier 214, which incorporates a heat exchanger 215, to match the operating temperature of the gas separation membrane unit 216. The CO₂ permeate gas that has permeated through the gas separation membrane unit 216 is passed through a vacuum pump 217 and a condenser 218 to capture the CO₂ gas. In the gas separation membrane unit 216, the retentate gas from the flue gas exits through a vent.

The gas separation membrane systems for CO₂ capture according to FIGS. 7 and 8 include a cooling process and a compression process before the module 133 including the gas separation membrane or the gas separation membrane unit 216.

Therefore, the system using the gas separation membrane 10, 10′ according to an embodiment has improved durability and improved high-temperature dimensional stability, which allows for expanding the operating range of the cooling process and compression process, thereby reducing CO₂ capture costs.

Hereinbelow, examples and comparative examples of the present disclosure will be described. However, the following examples are merely an example of the present disclosure, and the present closure is not limited to the following examples.

### EXAMPLES

### Comparative Reference Example 1: Porous Polymer Substrate

A polyethylene porous substrate (G14AB1, manufactured by Toray, average pore size: about 55 nm) with a thickness of 14.35 μm was prepared as a porous polymer substrate.

### Reference Example 1: Porous Polymer Substrate/Porous Ceramic (Al₂O₃)-Polymer (CMC) Layer

On one surface of the polyethylene porous substrate of Comparative Reference Example 1, a composition (solid content: about 20%) prepared by dissolving and mixing carboxymethyl cellulose (CMC) binder (carboxymethylcellulose sodium salt, medium viscosity, Sigma-Aldrich) and alumina (Al₂O₃) with a D₅₀ particle size of 0.9 μm in a weight ratio of 1:45 in deionized water was applied using a bar coater and dried at about 80° C. for 12 hours to form a porous ceramic-polymer layer with a thickness of about 4.7 μm (pore size: 320 nm).

### Reference Example 2: Porous Polymer Substrate/Porous Ceramic (Al₂O₃)-Polymer (Acrylic Copolymer/PVA) Layer

An acrylic copolymer binder was prepared as follows.

Into a 3 L four-neck flask equipped with a stirrer, a thermometer, and a condenser, distilled water (968 g), acrylic acid (45.00 g, 0.62 mol), ammonium persulfate (0.54 g, 2.39 mmol, added based on 1,500 ppm relative to monomer), 2-acrylamido-2-methylpropanesulfonic acid (5.00 g, 0.02 mol), and 5 N aqueous sodium hydroxide solution (0.8 equivalents relative to the total amount of acrylic acid and 2-acrylamido-2-methylpropanesulfonic acid) were added. Then, after repeating the operation of reducing the internal pressure to 10 mmHg with a diaphragm pump and returning the internal pressure to atmospheric pressure with nitrogen three times, acrylonitrile (50.00 g, 0.94 mol) was added.

The reaction mixture was reacted for 18 hours while maintaining the temperature stable between 65° C. and 70° C. After the second addition of ammonium persulfate (0.23 g, 1.00 mmol, added based on 630 ppm relative to monomer), the temperature was raised to 80° C., and the reaction was continued for another 4 hours. After cooling to room temperature, the pH of the reaction solution was adjusted to 7 to 8 using a 25% aqueous ammonia solution to prepare poly(acrylic acid-co-acrylonitrile-co-2-acrylamido-2-methylpropanesulfonic acid) sodium salt. The molar ratio of acrylic acid, acrylonitrile, and 2-acrylamido-2-methylpropanesulfonic acid was 39:59:2. About 10 m¹ of the reaction solution (reaction product) was taken, and the non-volatile content measured therefrom was found to be 9.0% (theoretical value: 10%).

In a manner similar to Reference Example 1 with an exception that a composition (solid content: about 30%), which was prepared by dissolving and mixing the prepared acrylic copolymer binder, poly(vinyl alcohol) (PVA) binder (Mw: 13,000-23,000, 87-89% hydrolyzed, Sigma-Aldrich) (weight ratio=70:30), and alumina (Al₂O₃) with a D₅₀ particle size of 0.9 μm in a weight ratio of 1:35 in deionized water, was applied using a bar coater and dried, a porous ceramic-polymer layer with a thickness of about 4.2 μm (pore size: 300 nm) was formed on one surface of the porous polymer substrate.

### Reference Example 3: Porous Polymer Substrate/Porous Ceramic (Mg(OH)₂)-Polymer (Acrylic Copolymer/PVA) Layer

In a manner similar to Reference Example 1 with an exception that a composition (solid content: about 30%), which was prepared by dissolving and mixing the acrylic copolymer binder prepared in Reference Example 2, PVA binder (Mw: 13,000-23,000, 87-89% hydrolyzed, Sigma-Aldrich) (weight ratio=90:10), and magnesium hydroxide (Mg(OH)₂) with a D₅₀ particle size of 1.2 μm in a weight ratio of 1:45 in deionized water, was applied using a bar coater and dried, a porous ceramic-polymer layer with a thickness of about 4.4 μm (pore size: 250 nm) was formed on one surface of the porous polymer substrate.

### Reference Example 4: Porous Polymer Substrate/Porous Ceramic (Al₂O₃)-Polymer (PUA/PVdF) Layer

In a manner similar to Reference Example 1 with an exception that a composition (solid content: about 40%), which was prepared by dissolving and mixing polyurethane acrylate (PUA) binder (SC2152, Miwon Specialty Chemical Co. Ltd.), PVdF binder (KF9300, Kureha) (weight ratio=50:50), and alumina (Al₂O₃) with a D₅₀ particle size of 0.9 μm in a weight ratio of 1:8 in an acetone/dimethylacetamide (DMAc) mixed solvent (weight ratio=80:20), was applied using a bar coater and dried, a porous ceramic-polymer layer with a thickness of about 4.4 μm (pore size: 200 nm) was formed on one surface of the porous polymer substrate.

### Reference Example 5: Porous Polymer Substrate/Porous Ceramic (Al₂O₃)-Polymer (PUA/PVdF) Layer

In a manner similar to Reference Example 1 with an exception that a composition (solid content: about 25%), which was prepared by dissolving and mixing PUA binder (SC2152, Miwon Specialty Chemical Co. Ltd.), PVdF binder (KF9300, Kureha) (weight ratio=50:50), and alumina (Al₂O₃) with a D₅₀ particle size of 0.9 μm in a weight ratio of 1:20 in an acetone/dimethylacetamide (DMAc) mixed solvent (weight ratio=80:20), was applied using a bar coater and dried, a porous ceramic-polymer layer with a thickness of about 4.5 μm (pore size: 220 nm) was formed on one surface of the porous polymer substrate.

### Example 1: Gas Separation Membrane

On the other surface of the porous polymer substrate prepared in Reference Example 1, which had the porous ceramic (Al₂O₃)-polymer (CMC) layer formed on one side, a composition (solid content: about 6%), which was prepared by dissolving and mixing polyethylene (PEO)-polyamide (PA6) block copolymer (PEO content=about 57 wt %, Mw: 140,000 g/mol, PEBAX 1657, Arkema) in a mixed solvent of ethanol and water (weight ratio=7:3), was applied using a bar coater and dried at about 60° C. for 12 hours to form a gas separation layer with a thickness of about 516 nm, thereby manufacturing a gas separation membrane.

### Example 2: Gas Separation Membrane

In a manner similar to Example 1 with an exception that a gas separation layer with a thickness of about 343 nm was formed by applying the composition, which was prepared by dissolving and mixing PEO-polyamide (PA6) block copolymer (PEO content=about 57 wt %, Mw: 140,000 g/mol, PEBAX 1657, Arkema) in a mixed solvent of ethanol and water (weight ratio=7:3) (solid content: about 6%), using a bar coater and drying, a gas separation membrane was manufactured.

### Example 3: Gas Separation Membrane

In a manner similar to Example 1 with an exception that a gas separation layer with a thickness of about 265 nm was formed by applying the composition, which was prepared by dissolving and mixing PEO-polyamide (PA6) block copolymer (PEO content=about 57 wt %, Mw: 140,000 g/mol, PEBAX 1657, Arkema) in a mixed solvent of ethanol and water (weight ratio=7:3) (solid content: about 3%), using a bar coater and drying, a gas separation membrane was manufactured.

### Example 4: Gas Separation Membrane

In a manner similar to Example 1 with an exception that a gas separation layer with a thickness of about 249 nm was formed by applying the composition, which was prepared by dissolving and mixing PEO-polyamide (PA6) block copolymer (PEO content=about 57 wt %, Mw: 140,000 g/mol, PEBAX 1657, Arkema) in a mixed solvent of ethanol and water (weight ratio=8:2) (solid content: about 3%), using a bar coater and drying, a gas separation membrane was manufactured.

### Example 5: Gas Separation Membrane

In a manner similar to Example 1 with an exception that a gas separation layer with a thickness of about 163 nm was formed by applying the composition, which was prepared by dissolving and mixing PEO-polyamide (PA6) block copolymer (PEO content=about 57 wt %, Mw: 140,000 g/mol, PEBAX 1657, Arkema) in a mixed solvent of ethanol and water (weight ratio=8:2) (solid content: about 3%), using a bar coater and drying, a gas separation membrane was manufactured.

### Evaluation Example 1: Scanning Electron Microscope (SEM) Analysis-Substrate, Ceramic-Polymer Layer, Gas Separation Layer

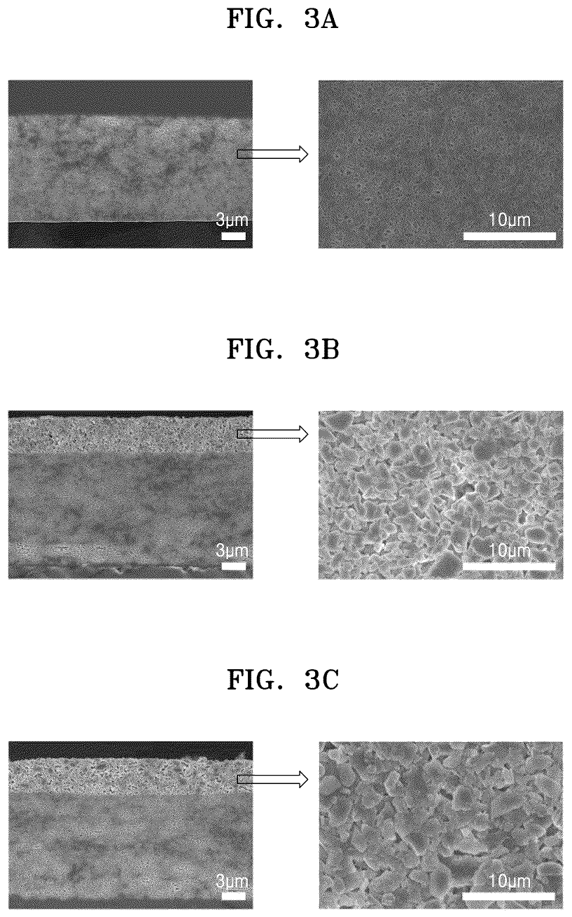

SEM analysis was conducted to confirm the surface and thickness of each layer for the porous polymer substrate of Comparative Reference Example 1 and the porous polymer substrate/porous ceramic-polymer layers prepared in Reference Example 1 and Reference Example 3. The results are shown in FIGS. 3A, 3B, and 3C, respectively. The SEM used for the SEM analysis was a Hitachi SU-8030, and images were taken at ×4,000 and ×50,000 magnifications, respectively.

Referring to FIG. 3A, the thickness of the porous polymer substrate of Comparative Reference Example 1 is about 15 μm, and pores sized about 50 nm to 60 nm formed on the surface are observed.

Referring to FIG. 3B, the porous polymer substrate/porous ceramic-polymer layer prepared in Reference Example 1, the thickness of the porous ceramic-polymer layer is about 4.7 μm, and Al₂O₃ ceramic material with about 0.9 μm particle size and pores sized about 320 nm are formed on the surface.

Referring to FIG. 3C, the porous polymer substrate/porous ceramic-polymer layer prepared in Reference Example 3, the thickness of the porous ceramic-polymer layer is about 4.4 μm, and the surface shows Mg(OH)₂ ceramic material with about 1.2 μm particle size and pores sized about 250 nm.

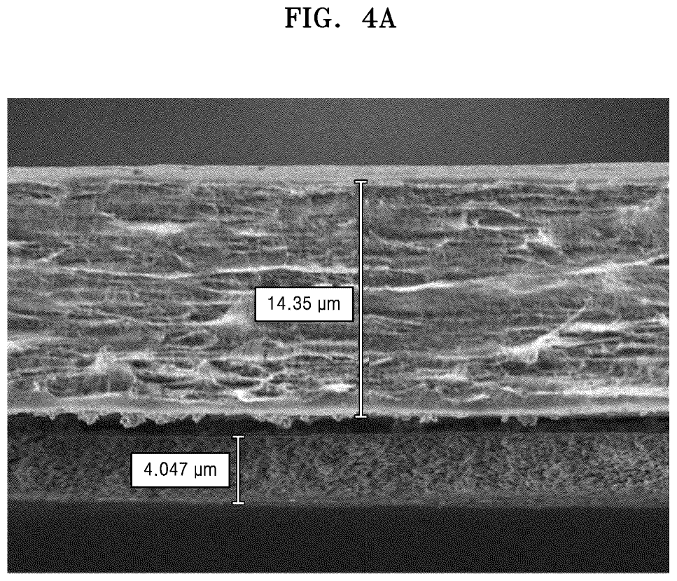

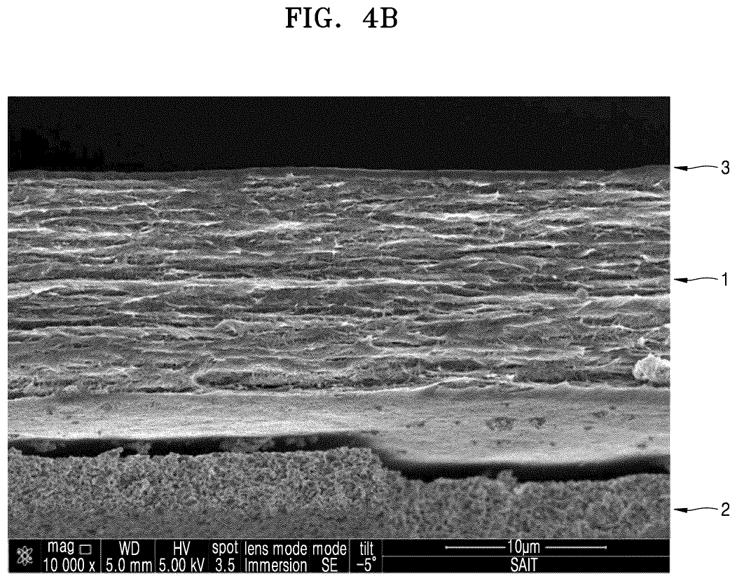

Furthermore, SEM analysis was conducted to confirm the thickness of each layer of the porous polymer substrate/porous ceramic-polymer layer prepared in Reference Example 1 and the gas separation membrane prepared in Example 1. The results are shown in FIGS. 4A and 4B, respectively.

Referring to FIGS. 4A and 4B, the structure of the gas separation membrane can be confirmed as gas separation layer 3 with a thickness of 516 nm/porous polymer substrate 1 with a thickness of 14.35 μm/porous ceramic-polymer layer 2 with a thickness of 4.047 μm.

### Evaluation Example 2: Physical Property Evaluation of Porous Polymer Substrate/Porous Ceramic-Polymer Layer

Physical properties were evaluated as follows for all or part of the porous polymer substrate of Comparative Reference Example 1 and the porous polymer substrate/porous ceramic-polymer layers prepared in Reference Example 1 to Reference Example 5.

### (1) Change in Air Permeability

For each porous polymer substrate/porous ceramic-polymer layer, the air permeability was measured before and after the coating of the porous ceramic-polymer layer, respectively, and the difference in air permeability before and after coating was defined as the change in air permeability. The results are presented in Table 1. Air permeability was measured according to Japanese Industrial Standard (JIS) 9117:1998 Gurley (JIS Gurley). The JIS Gurley value is defined as the time (seconds) required for 100 cc of nitrogen (N₂) gas to permeate through a unit area of 1 inch² of the porous polymer substrate or the porous polymer substrate/porous ceramic-polymer layer at a constant pressure of 0.05 MPa.

### (2) Shrinkage Rate (%) in Machine Direction (MD) and Transverse Direction (TD)-Heat Resistance Evaluation

Each 4 cm×4 cm area sample of the porous polymer substrate/porous ceramic-polymer layer was heated in a 150° C. oven for 1 hour, and the lengths in the machine direction (MD) and transverse direction (TD) of the part indicated by arrows in the longitudinal and transverse directions in FIG. 9 were measured before and after heating, respectively. The measured lengths were substituted into Equation 2-1 to calculate the shrinkage rate (%) in the machine direction (MD) and transverse direction (TD). The results are presented in Table 1.

$$Shrinkage rate ( \% ) = [ \frac{( 1 - D h )}{D 0} \times 100 ] \qquad [ Equation 2 ‐ 1 ]$$

In Equation 2-1,
D0 represents the length before heating in the MD direction or TD direction of the porous polymer substrate/porous ceramic-polymer layer, and
Dh represents the length in the MD direction or TD direction after heating the porous polymer substrate/porous ceramic-polymer layer at a temperature of 150° C. for 1 hour.

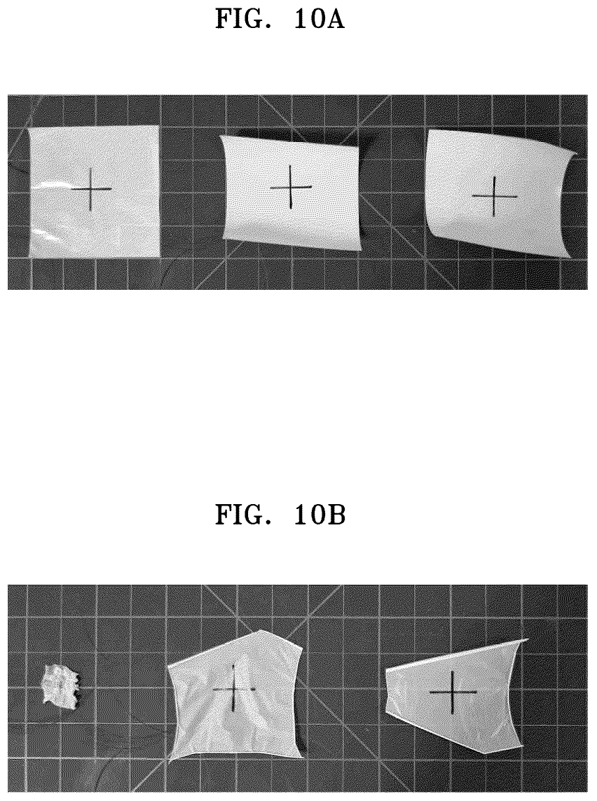

Additionally, photographs were taken showing the appearance before and after heating the porous polymer substrate of Comparative Reference Example 1 and the porous polymer substrate/porous ceramic-polymer layer prepared in Reference Example 1 in a 150° C. oven for 1 hour. The results are shown in the left and center of FIGS. 10A and 10B, respectively.

The left photographs in FIGS. 10A and 10B show the appearance of the porous polymer substrate of Comparative Reference Example 1 before and after heating.

The center photographs in FIGS. 10A and 10B show the appearance before and after heating for the porous polymer substrate/porous ceramic-polymer layer prepared in Reference Example 1, and the porous polymer substrate/porous ceramic-polymer layer/gas separation layer prepared in Example 1.

(3) Carbon Dioxide (CO₂) Permeability (cm³/s cm² cmHg)

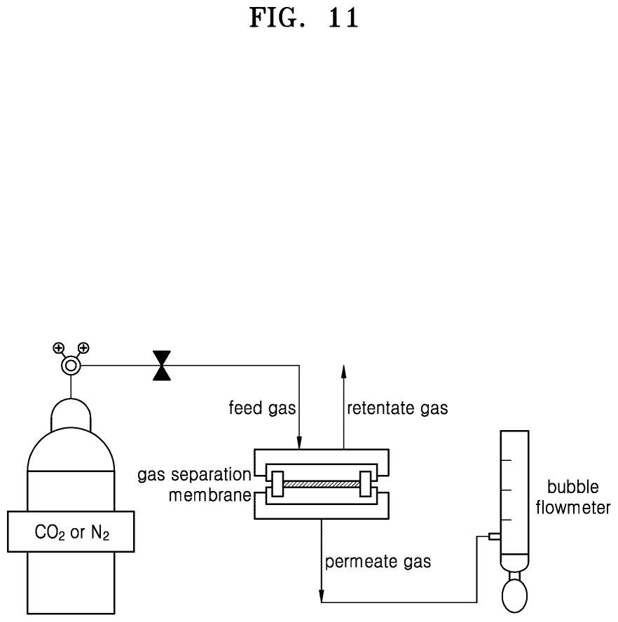

The carbon dioxide (CO₂) permeability for the porous polymer substrate of Comparative Reference Example 1 and the porous polymer substrate/porous ceramic-polymer layer prepared in Reference Example 1 was measured using the apparatus shown in FIG. 11 at a pressure of 0.2 bar using a bubble flowmeter. The results are presented in Table 1. Here, 1 GPU is defined as =10⁻⁶ cm³_{STP}/cm²·s·cmHg.

TABLE 1

| | | | | | | Comparison |
|---|---|---|---|---|---|---|
| | Reference | Reference | Reference | Reference | Reference | Reference |
| Item | Example 1 | Example 2 | Example 3 | Example 4 | Example 5 | Example 1 |
| Ceramic material | Al₂O₃ | Al₂O₃ | Mg(OH)₂ | Al₂O₃ | Al₂O₃ | — |
| (C) | | | | | | |
| Polymer binder | CMC | PAA/ | PAA/ | PUA/ | PUA/ | — |
| (B) | | PVA | PVA | PVdF | PVdF | |
| B:C weight ratio | 1:45 | 1:35 | 1:45 | 1:8 | 1:20 | — |
| Ceramic-polymer | 4.7 | 4.2 | 4.4 | 4.4 | 4.5 | 0 |
| layer thickness | | | | | | |
| (μm) | | | | | | |
| Air permeability | 10 | 10 | 10 | 20 | 20 | — |
| change | | | | | | |
| MD/TD Shrinkage | <5 | <5 | <5 | <5 | <5 | Not |
| rate (%) | | | | | | measurable |
| @150° C., 1 hr | | | | | | |
| CO₂ Permeability | 0.03564 | — | — | — | — | 0.036 |
| (10⁻⁶ cm³_{STP}/cm² s | | | | | | |
| cmHg) | | | | | | |

Referring to Table 1, for the porous polymer substrate/porous ceramic-polymer layers prepared in Reference Example 1 to Reference Example 5, the change in air permeability before and after coating the porous ceramic-polymer layer was measured as 10 seconds to 20 seconds, and the MD/TD shrinkage rates before and after heating were both less than 5%. The CO₂ permeability of the substrate/porous ceramic-polymer layer prepared in Reference Example 1 was measured as 0.03564×10⁻⁶ cm³_{STP}/(cm²·s·cmHg).

Referring to FIGS. 10A and 10B, the part indicated by arrows in the longitudinal and transverse directions of the porous polymer substrate prepared in Comparative Reference Example 1 shrank significantly before and after heating. On the other hand, in the case of the porous polymer substrate/porous ceramic-polymer layer prepared in Reference Example 1 and the porous polymer substrate/porous ceramic-polymer layer/gas separation layer prepared in Example 1, the part indicated by arrows in the longitudinal and transverse directions hardly shrank before and after heating.

### Evaluation Example 3: Gas Separation Performance Evaluation of Gas Separation Membrane

The gas separation performance was evaluated as follows for the gas separation membranes prepared in Examples 1 to 5.

(1) CO₂ Permeability, N₂ Permeability, and CO₂/N₂ Selectivity

For each gas separation membrane, the CO₂ permeability and N₂ permeability were measured respectively using the apparatus shown in FIG. 11 at a pressure of 0.2 bar using a bubble flowmeter. The measured CO₂ permeability and N₂ permeability were substituted into Equation 1 to calculate the selectivity

$$( S \frac{CO 2}{N 2} ) .$$

The results are presented in Table 2. In this case, 1 GPU is defined as =10⁻⁶ cm³/(cm²·s·cmHg).

$$S \frac{C O 2}{N 2} = \frac{Carbon dioxide ( CO 2 ) permeability}{Nitrogen ( N 2 ) permeabi1ity} . \qquad [ Equation 1 ]$$

(2) Shrinkage rate (%) in machine direction (MD) and transverse direction (TD)-Heat resistance evaluation Each 4 cm×4 cm area sample of the gas separation membrane was heated in a 150° C. oven for 1 hour, and the lengths in the machine direction (MD) and transverse direction (TD) of the part indicated by arrows in the longitudinal and transverse directions in FIG. 9 were measured before and after heating, respectively. The measured lengths were substituted into Equation 2 to calculate the shrinkage rate (%) in the machine direction (MD) and transverse direction (TD). The results are presented in Table 2.

$$Shrinkage rate ( \% ) = [ \frac{( 1 - D h )}{D 0} \times 100 ] \qquad [ Equation 2 ]$$

In Equation 2,
D0 represents the length before heating in the MD direction or TD direction of the gas separation membrane, and
Dh represents the length in the MD direction or TD direction after heating the gas separation membrane at a temperature of 150° C. for 1 hour.

Additionally, photographs were taken showing the appearance before and after heating the gas separation membrane prepared in Example 1 in a 150° C. oven for 1 hour. The results are shown on the right of FIGS. 10A and 10B, respectively.

TABLE 2

| | Example | Example | Example | Example | Example |
|---|---|---|---|---|---|
| Item | 1 | 2 | 3 | 4 | 5 |
| Solvent ratio | 7:3 | 7:3 | 7:3 | 8:2 | 8:2 |
| (EtOH:Water) | | | | | |
| Gas separation layer | 516 | 343 | 265 | 249 | 163 |
| thickness (nm) | | | | | |
| CO₂ Permeability | 1.05 × 10⁻⁴ | 1.29 × 10⁻⁴ | 1.80 × 10⁻⁴ | 2.15 × 10⁻⁴ | 2.17 × 10⁻⁴ |
| (cm³/cm² · s · cmHg) | | | | | |
| N₂ Permeability | 2.0 × 10⁻⁶ | 2.6 × 10⁻⁶ | 5.6 × 10⁻⁶ | 6.1 × 10⁻⁶ | 7.3 × 10⁻⁶ |
| (cm³/cm² · s · cmHg) | | | | | |
| $Selectivity ( S \frac{CO 2}{N 2} )$ | 52.1 | 49.3 | 32.1 | 35.4 | 29.7 |
| MD/TD Shrinkage rate | < 5 | < 5 | < 5 | < 5 | < 5 |
| (%) @150° C., 0.5 hr | | | | | |

Referring to Table 2, the selectivity

$$( S \frac{CO2}{N 2}$$

of the gas separation membranes prepared in Example 1 to Example 5 was 29.7 or higher, and the MD/TD shrinkage rates before and after heating were both less than 5%.

Referring to FIGS. 10A and 10B, the gas separation membrane prepared in Example 1 hardly shrank before and after heating, while maintaining the shape of the part indicated by arrows in the longitudinal and transverse directions.

From this, it can be understood that the gas separation membrane according to an embodiment possesses excellent durability along with excellent high-temperature dimensional stability and CO₂ gas separation performance.

The gas separation membrane according to one aspect includes a porous polymer substrate, a porous ceramic-polymer layer, and a gas separation layer. The thickness of the gas separation layer may be about 0.1% to about 20% relative to the thickness of the porous ceramic-polymer layer, and the thickness of the porous ceramic-polymer layer may be about 0.1% to about 50% relative to the thickness of the porous polymer substrate. The porous ceramic-polymer layer is an organic-inorganic composite layer comprising a polymer binder having a melting point (Tₘ) of at least 180° C. and a ceramic material. The gas separation membrane possesses improved durability, improved high-temperature dimensional stability, and CO₂ gas separation performance simultaneously.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A gas separation membrane comprising:
a porous polymer substrate;
a porous ceramic-polymer layer on a surface of the porous polymer substrate; and
a gas separation layer on an opposite surface of the porous polymer substrate,
wherein the gas separation layer has a thickness of about 0.1% to about 20% relative to a thickness of the porous ceramic-polymer layer,
wherein the porous ceramic-polymer layer has a thickness of about 0.1% to about 50% relative to the thickness of the porous polymer substrate,
wherein the porous ceramic-polymer layer is an organic-inorganic composite layer including a polymer binder having a melting point of 180° C. or greater and a ceramic material,
wherein the polymer binder comprises at least one of a cellulose-based binder, a vinyl alcohol-based binder, or an acrylate-based binder, each of which including a functional group on a side chain, and
wherein the functional group comprises at least one of —COOH, —NH₂, —OH, —SO₃H, or —CN, or a cation thereof, an anion thereof, or a salt thereof.

2. The gas separation membrane of claim 1,
wherein, in the porous ceramic-polymer layer, the ceramic material is connected to and fixed by the polymer binder.

3. The gas separation membrane of claim 1,
wherein the ceramic material is a spherical ceramic material having an average particle size of about 0.1 micrometer to about 1 micrometer, a plate-shaped ceramic material having an average particle size of about 0.1 micrometer to about 10 micrometer, or a mixed structure thereof,
wherein the spherical ceramic material comprises at least one of alumina (Al₂O₃), boehmite (γ-AlO(OH)), or silica (SiO₂), and
the plate-shaped ceramic material comprises at least one of magnesium hydroxide, aluminum hydroxide, mica, clay, or talc.

4. The gas separation membrane of claim 1,
wherein a weight ratio of the polymer binder to the ceramic material is about 1:8 to about 1:45.

5. The gas separation membrane of claim 1,
wherein the porous ceramic-polymer layer has a pore size of about 10 nanometers to about 999 nanometers, and
the porous polymer substrate has an average pore size of about 50 nanometers to about 80 nanometers.

6. The gas separation membrane of claim 1,
wherein the porous polymer substrate comprises a polyolefin-based polymer and has a thickness of about 10 micrometers to about 40 micrometers.

7. The gas separation membrane of claim 1,
wherein the gas separation layer comprises a polymer or copolymer having a C1-C5 alkylene oxide structural unit in a main chain,
the polymer or copolymer has a weight-average molecular weight of about 50,000 g/mol to about 200,000 g/mol, and
a content of the C1-C5 alkylene oxide structural unit is about 50 wt % to about 100 wt % based on 100 wt % of total structural units of the main chain.

8. The gas separation membrane of claim 7,
wherein the copolymer comprises a block copolymer including a rubbery structural unit of a C1-C5 alkylene oxide and a hard structural unit in a main chain,
wherein the rubbery structural unit has a glass transition temperature of about-80° C. to about −50° C.

9. The gas separation membrane of claim 1,
wherein the gas separation layer is capable of separating carbon dioxide from nitrogen gas, and
CO₂/N₂ selectivity
$$( S \frac{C O 2}{N 2} )$$
as defined by Equation 1 is about 20 to about 100:
$$S \frac{CO2}{N 2} = \frac{Carbon dioxide ( CO2 ) permeability}{Nittogen ( N2 ) permeabi1ity} . \qquad Equation 1$$

10. The gas separation membrane of claim 1,
wherein a shrinkage rate in both a machine direction and a transverse direction, as defined by Equation 2, is greater than 0% and less than 5%:
$$Shrinkage rate ( \% ) = [ \frac{( 1 - D h )}{D 0} \times 100 ] \qquad Equation 2$$
wherein, in Equation 2,
D0 represents a length of the gas separation membrane before heating in the machine direction or the transverse direction, and
Dh represents a length of the gas separation membrane in the machine direction or the transverse direction after heating at 150° C. for 1 hour.

11. A method of preparing a gas separation membrane, the method comprising:
providing a porous polymer substrate;
forming a porous ceramic-polymer layer by applying a porous ceramic-polymer layer-forming composition onto a surface of the porous polymer substrate; and
forming a gas separation layer by applying a gas separation layer-forming composition onto an opposite surface of the porous polymer substrate to prepare a gas separation membrane,
wherein the porous ceramic-polymer layer-forming composition comprises a polymer binder having a melting point of 180° C. or greater and a ceramic material,
wherein the polymer binder comprises at least one of a cellulose-based binder, a vinyl alcohol-based binder, or an acrylate-based binder, each of which having a functional group on a side chain, and
wherein the functional group comprises at least one of —COOH, —NH₂, —OH, —SO₃H, or —CN, or a cation thereof, an anion thereof, or a salt thereof,
wherein the porous ceramic-polymer layer has a thickness of about 0.1% to about 50% relative to the thickness of the porous polymer substrate, and
wherein the gas separation layer has a thickness of about 0.1% to about 20% relative to a thickness of the porous ceramic-polymer layer.

12. The method of claim 11,
wherein the ceramic material is a spherical ceramic material having an average particle size of about 0.1 micrometers to about 1 micrometer, a plate-like ceramic material having an average particle size of about 0.1 micrometers to about 10 micrometers, or a mixed structure thereof,
wherein the spherical ceramic material comprises at least one of alumina (Al₂O₃), boehmite (γ-AlO(OH)), or silica (SiO₂), and
wherein the plate-like ceramic material comprises at least one of magnesium hydroxide (Mg(OH)₂), aluminum hydroxide (Al(OH)₃), mica, clay, or talc.

13. The method of claim 11,
wherein a weight ratio of the polymer binder to the ceramic material is about 1:8 to about 1:45.

14. The method of claim 11,
wherein the porous polymer substrate comprises a polyolefin-based polymer, and has a thickness of about 10 micrometers to about 40 micrometers.

15. The method of claim 11,
wherein the gas separation layer comprises a polymer or copolymer having a C1-C5 alkylene oxide structural unit in a main chain,
the polymer or copolymer has a weight-average molecular weight (Mw) of about 50,000 g/mol to about 200,000 g/mol, and
a content of the C1-C5 alkylene oxide structural unit is at least about 50 wt % to about 100 wt % based on 100 wt % of total structural units of the main chain.

16. The method of claim 11,
wherein the gas separation layer is capable of separating carbon dioxide/nitrogen gas, and
CO₂/N₂ selectivity
$$( S \frac{CO2}{N 2} )$$
as defined by Equation 1 is about 20 to about 100:
$$S \frac{CO2}{N 2} = \frac{Carbon dioxide ( CO 2 ) permeability}{Nitrogen ( N2 ) permeability} . \qquad Equation 1$$

17. The method of claim 11,
wherein a shrinkage rate of the gas separation membrane in both a machine direction and a transverse direction, as defined by Equation 2, is greater than 0% and less than 5%:
$$Shrinkage rate ( \% ) = [ \frac{( 1 - D h )}{D 0} \times 100 ] \qquad Equation 2$$
wherein, in Equation 2,
D0 represents a length of the gas separation membrane before heating in the machine direction or transverse direction, and
Dh represents a length of the gas separation membrane in the machine direction or transverse direction after heating at 150° C. for 0.5 hour.

18. A module comprising:
a gas inlet to introduce a feed gas;
at least one feed channel connected to the gas inlet;
at least one permeate channel arranged in parallel and spaced apart from the at least one feed channel;
at least one gas separation membrane disposed between the at least one feed channel and the at least one permeate channel;
a permeate collection member connected to the at least one permeate channel for collecting permeate gas; and
a gas outlet on a side of the module opposite the gas inlet to discharge retentate gas not collected by the permeate collection member,
wherein the at least one gas separation membrane comprises:
a porous polymer substrate;
a porous ceramic-polymer layer on a surface of the porous polymer substrate; and
a gas separation layer on an opposite surface of the porous polymer substrate,
wherein the gas separation layer has a thickness of about 0.1% to about 20% relative to a thickness of the porous ceramic-polymer layer,
wherein the porous ceramic-polymer layer has a thickness of about 0.1% to about 50% relative to the thickness of the porous polymer substrate,
wherein the porous ceramic-polymer layer is an organic-inorganic composite layer including a polymer binder having a melting point of 180° C. or greater and a ceramic material,
wherein the polymer binder comprises at least one of a cellulose-based binder, a vinyl alcohol-based binder, and an acrylate-based binder, each having a functional group on a side chain, and
wherein the functional group comprises at least one of —COOH, —NH₂, —OH, —SO₃H, or —CN, or a cation thereof, an anion thereof, or a salt thereof.

19. The module of claim 18,
wherein the at least one feed channel comprises two or more adjacent feed channels, and
at least one baffle is provided between the adjacent feed channels.

20. The module of claim 18,
wherein the feed gas comprises carbon dioxide and nitrogen, and
CO₂/N₂ selectivity
$$( S \frac{C O 2}{N 2} )$$
as defined by Equation 1 is about 20 to about 100:
$$S \frac{CO2}{N 2} = \frac{Carbon dioxide ( CO2 ) permeability}{Nitrogen ( N2 ) permeability} . \qquad Equation 1$$
